(19) United States
(12) Patent Application Publication
(10) Pub. No.: US 2020/0339264 A1
(43) Pub. Date: Oct. 29, 2020

(54) PISTON DEVICE FOR USE WITH AIRCRAFT SEAT

(71) Applicant: CRANE CO., Stamford, CT (US)

(72) Inventor: Ricardo Baldomero, Cloverdale, CA (US)

(21) Appl. No.: 16/708,208

(22) Filed: Dec. 9, 2019

Related U.S. Application Data
(60) Provisional application No. 62/838,853, filed on Apr. 25, 2019.

(51) Int. Cl. B64D 11/06

(52) U.S. Cl. CPC B64D 11/0619; B64D 11/0639

(57) ABSTRACT

A threshold-activated piston device with dampened response for use an aircraft seat, includes a chamber, a piston, a releasable fastener and a coupler, wherein the fastener is configured to release the piston for a stroke in response to an impact force that exceeds a predetermined threshold. The predetermined threshold may be set by a friction member, spring, a tension fastener, a check valve mechanism and/or a catch mechanism. Motion of the piston device resulting from the impact force imparted is dampened by conversion of kinetic energy into thermal energy. The method of energy conversion may be through, but not limited to, friction, viscous damping or velocity squared damping. The piston device may be configured for reuse in allowing the stroke to be reset. Additional fluid ports and/or a spring enables resetting of the stroke.

### CROSS-REFERENCE TO RELATED APPLICATION(S)

This application claims priority to and the benefit of U.S. Provisional Patent Application No. 62/838,853 filed Apr. 25, 2019 and titled AIRCRAFT SEAT HEAD IMPACT CRITERIA PISTON DEVICE, the entire content of which is incorporated herein by reference.

### FIELD OF INVENTION

This disclosure relates to a piston device, in particular, a Head Injury Criterion (“HIC”) piston device configured for use with an aircraft seat.

### BACKGROUND

During most aircraft crashes, the force of the impact can send the head of a seated passenger forward striking the back of the seat in front despite the proper use of safety belt and assumption of the crash position. As such, Head Injury Criterion (“HIC”) tests set requirements for energy dissipation that limit the amount of allowable impact of a passenger head striking an aircraft seat back. These tests define HIC according to the following equation:

$$H l C = {[ {( {t}_{2} - {t}_{1} ) [ \frac{1}{( {t}_{2} - {t}_{1} )} {\int }_{{t}_{1}}^{{t}_{2}} a ( t ) d t ]}^{2.5} ]}_{ma x} \qquad Eqn ( 1 )$$

Where t₁ and t₂ are any two points in time during the impact that maximize the value of HIC and a(t) is the acceleration of the head as measured by an accelerometer. For context, aircraft seats must meet the testing requirements of 14 CFR § 25.562 wherein the measured HIC value according to the specified testing procedures shall not exceed 1000. Aircraft seat manufacturers attempt to design seats so that they have sufficient compliance and energy absorption to lower the measured value of HIC in order to meet the test requirements. However, in some cases, the structure of the seat is too stiff or it does not dissipate enough energy. Although seat manufacturers often rely on collapsible elements, friction elements or compliant surfaces in order to dissipate energy during an impact, these types of elements can be difficult to control and costly to implement.

An additional post-crash safety measure limits the extent to which the seat back can be folded forward so that it does not block egress of passengers exiting the aircraft. However, during normal operation, seat back compliance also requires that the seat back resists forward movement when the seat back is pushed forward by a passenger walking the aisle and using the seat back for support during air turbulence. These features of the aircraft seat are commonly accomplished through the use of a locking linkage.

Currently, in aircraft cabin seating, a locking linkage is used to control the movement of the seat back between an upright position and a reclined position via a release button. When the seat back is in the upright position, actuation of the release button allows the seat back to recline in response to a seated passenger actively reclining the seat back. When the seat back is in the reclined position, actuation of the release button enables a spring-type mechanism in the locking arm to push the seat back returning it to the upright position. The motion of the seat back into the reclined position from the upright position is opposite the direction of motion of the seat back during an aft impact crash. Moreover, an impact position of the seat back following a crash may be further forward of the upright position, which would place the spring-type mechanism into tension rendering it and the seat back relatively rigid. In this scenario, the locking linkage's ability to help reduce the HIC value is compromised.

### SUMMARY

A threshold-activated piston device for use with an aircraft seat is set into a motion of a stroke only when it is subjected to an impact force that exceeds a predetermined threshold. Moreover, the motion of the piston device resulting from the impact force imparted is damped by conversion of kinetic energy into thermal energy. Additionally, the piston device may be configured for reuse in allowing the stroke to be reset for an additional activation by a subsequent impact force that exceeds the predetermined threshold.

In some embodiments, a threshold-activated piston device for use with an aircraft susceptible and responsive to an impact force includes an elongated chamber, a piston, and means for conditionally releasing the piston for motion in a distal direction relative to the chamber only when the piston is subjected to an impact force greater than a predetermined threshold.

In some embodiments, the means for conditionally releasing the piston include a friction-inducing member between a surface of the piston and a surface of the chamber, the friction-inducing member configured to provide the predetermined threshold over which the impact force must overcome in order to activate the piston.

In some embodiments, the means for conditionally releasing the piston include a tension bolt configured to rupture only when the impact force is greater than the predetermined threshold.

In some embodiments, the means for conditionally releasing the piston include a pre-loaded spring configured to compress only when the impact force is greater than the predetermined threshold.

In some embodiments, the means for conditionally releasing the piston include a check valve mechanism defining a proximal flow direction, the check valve mechanism configured to open for fluid flow in the proximal flow direction only when the impact force is greater than the predetermined threshold.

In some embodiments, the means for conditionally releasing the piston include a catch mechanism with a male member and a female member, the catch mechanism having male and female members that disengage only when the impact force is greater than the predetermined threshold.

In some embodiments, the piston device includes means for damping motion of the piston after the piston is released for movement relative to the chamber.

In some embodiments, the means for damping motion include a friction-inducing member between a surface of the piston and a surface of the chamber.

In some embodiments, the means for damping motion include hydraulic port damping mechanisms applying velocity squared hydraulic damping, wherein the hydraulic port damping mechanisms include fluid in the chamber and at least one port in the piston configured to pass the fluid.

In some embodiments, the fluid includes a rheological fluid whose viscosity is responsive to an electric current or a magnetic field.

In some embodiments, the means for damping motion include hydraulic valve damping mechanisms applying variable hydraulic damping, wherein the hydraulic valve damping mechanisms include a check valve mechanism defining a fluid flow direction, and a spring to control the valve opening, the check valve mechanism configured to open for fluid flow in the flow direction only when the impact force is greater than the predetermined threshold, and the amount of valve opening proportional to the pressure, to change the damping to approximate a proportional damper.

In some embodiments, the piston device includes means for resetting the piston.

In some embodiments, the means for resetting include a spring.

In some embodiments, the means for resetting include a check valve mechanism defining a distal flow direction to the motion of the piston following the conditional release.

In some embodiments, a threshold-activated piston device for use with an aircraft seat susceptible and responsive to an impact force includes an elongated chamber, a piston, a releasable tension fastener and a coupler. The chamber has a proximal end and a distal end and defines a longitudinal axis. The piston has a head and a shaft extending along the longitudinal axis and is configured for translation along the longitudinal axis from a compressed configuration into an extended configuration in response to the impact force. The tension fastener secures the piston to the proximal end, with the tension fastener being configured to release the piston from the proximal end for the translation when the tension fastener is ruptured by an impact force exceeding a predetermined threshold. The coupler is configured to couple the shaft to the aircraft seat so that the translation of the piston acts on the seat.

In some embodiments, the piston has a longitudinal port configured to pass hydraulic fluid from a first portion of the chamber distal the piston head to a second portion of the chamber proximal the piston head as the piston translates from the compressed configuration into the extended configuration.

In some embodiments, the piston device includes a friction member configured to dissipate energy during translation of the piston from the proximal end to the distal end of the chamber.

In some embodiments, the piston device includes a friction member and an energy-dissipating mechanism.

In some embodiments, the piston device includes a rheological fluid housed in the chamber, the rheological fluid having a viscosity responsive to an electric current that is passed though the rheological fluid.

In some embodiments, the piston device further comprises a spring surrounding a shaft of the piston.

In some embodiments, the spring is configured to translate the piston from the extended configuration back to the compressed configuration after the piston device has responded to the impact force.

In some embodiments, the tension fastener is a bolt whose shaft extends into the piston head.

In some embodiments, the shaft is generally parallel with the longitudinal axis.

In some embodiments, a piston device for use with an aircraft seat susceptible and responsive to an impact force includes an elongated chamber, a piston, a first check valve mechanism and a coupler. The chamber has a proximal end and a distal end and the chamber defines a longitudinal axis. The piston has a piston head and a shaft extending along the longitudinal axis, the piston configured for translation along the longitudinal axis between a compressed configuration and an extended configuration in response to the impact force. The first check valve mechanism is situated in the fluid channel and is configured to define a first valve flow direction. The first check valve includes a first valve member and a first bias member, with the valve member being configured to move between a closed position blocking the fluid channel, and an open position allows hydraulic fluid to flow through the fluid channel from the second portion of the chamber distal the piston head to the first portion of the chamber proximal the piston head. The bias member is configured to bias the first valve member in the closed position except when the impact force exceeds a predetermined threshold. The coupler is configured to couple the shaft to the aircraft seat so that the translation of the piston acts on the seat.

In some embodiments, the valve member includes a ball and the bias member includes a spring.

In some embodiments, the fluid channel includes a longitudinal channel and a transverse channel.

In some embodiments, the longitudinal channel is formed in the piston head and the transverse channel is distal of the piston head.

In some embodiments, the piston device also includes a threaded member configured to adjust a bias force exerted by the bias member on the valve member.

In some embodiments, the piston device also includes a second check valve mechanism comprising a second valve member and a second bias member. The second check valve mechanism is configured to define a second valve flow direction that is generally opposite to the first flow direction.

In some embodiments, the second valve flow direction includes hydraulic fluid flowing from the first portion of the chamber proximal the piston head to the second portion of the chamber distal the piston head.

In some embodiments, the second check valve mechanism is formed in the piston head.

In some embodiments, a piston device for use with an aircraft seat susceptible to an impact force includes an elongated chamber, a piston, a catch mechanism and a coupler.

In some embodiments, the catch mechanism includes a pair of engaged male catch and female catch configured for disengagement when the impact force exceeds a predetermined threshold.

In some embodiments, one of the male and female catches is formed on a protrusion on a proximal face of the piston, and the other of the male and female catches is situated in the proximal end of the chamber.

In some embodiments, the piston device also includes a longitudinal fluid channel formed in the piston, the channel configured for fluid communication between a first portion of the chamber distal the piston head and a second portion of the chamber proximal of the piston head.

In some embodiments, an aircraft seat system susceptible and responsive to an impact force includes, an aircraft seat having a seat back and a piston device, where the piston device includes an elongated chamber, a piston and means for conditionally releasing the piston from the compressed configuration when the impact force has a vector component greater than a predetermined threshold.

In some embodiments, the system also includes means for dampening motion of the piston once released from the compression configuration.

In some embodiments, the system also includes means for returning the piston toward the compression configuration from the extended configuration.

### BRIEF DESCRIPTION OF THE DRAWINGS

These and other features and advantages of the present invention will be better understood by reference to the following detailed description when considered in conjunction with the accompanying drawings. It is understood that selected structures and features have not been shown in certain drawings so as to provide better viewing of the remaining structures and features.

FIG. 1A is a side cross-sectional view of a piston device with a friction-inducing member, according to a first embodiment, in a compressed configuration.

FIG. 1B is a side cross-sectional view of the piston device of FIG. 1A, in a mid-stroke configuration.

FIG. 1C is a side cross-sectional view of the piston device of FIG. 1A, in a full stroke, extended configuration.

FIG. 2A is a side view of a piston device as used with an aircraft seat, according to one embodiment.

FIG. 2B is a side view of a piston device as used with an aircraft seat, according to another embodiment.

FIG. 3A is a side cross-sectional view of the piston device with a tension fastener, according to a second embodiment, in a compressed configuration.

FIG. 3B is a side cross-sectional view the piston device of FIG. 1, in a mid-stroke configuration.

FIG. 3C is a side cross-sectional view of the piston device of FIG. 1, in a full stroke, extended configuration.

FIG. 4A is a side cross-sectional view of a piston device with a spring, according to a third embodiment, in a compressed configuration.

FIG. 4B is a side cross-sectional view the piston device of FIG. 4A, in a mid-stroke configuration.

FIG. 4C is a side cross-sectional view of the piston device of FIG. 4A, in a full stroke, extended configuration.

FIG. 5A is a side cross-sectional view of a piston device with at least one check valve mechanism, according to a fourth embodiment, in a compressed configuration.

FIG. 5B is a side cross-sectional view of the piston device of FIG. 5A, in a mid-stroke configuration.

FIG. 5C is a side cross-sectional view of the piston device of FIG. 5A, in a full stroke, extended configuration.

FIG. 5D is a side cross-sectional view of the piston of FIG. 5A, returning to the compressed configuration.

FIG. 5E is a detailed view of a portion of FIG. 4B.

FIG. 6A is a side cross-sectional view of a piston device of FIG. 5A with a spring, according to a fifth embodiment, in a compressed configuration.

FIG. 6B is a side cross-sectional view the piston device of FIG. 5A, in a mid-stroke configuration.

FIG. 6C is a side cross-sectional view of the piston device of FIG. 5A, in a full stroke, extended configuration.

FIG. 7A is a side cross-sectional view of a piston device with at least one catch mechanism, according to a sixth embodiment, in a compressed configuration.

FIG. 7B is a side cross-sectional view the piston device of FIG. 7A, in a mid-stroke configuration.

FIG. 7C is a side cross-sectional view of the piston device of FIG. 7A, in a full stroke, extended configuration.

FIG. 7D is a detailed view of a portion of FIG. 7A.

FIG. 7E is an end-sectional view of FIG. 7C, taken along line AA-AA.

### DETAILED DESCRIPTION

The following detailed description should be read with reference to the drawings, in which like elements in different drawings are identically numbered. The drawings, which are not necessarily to scale, depict selected embodiments and are not intended to limit the scope of the present disclosure.

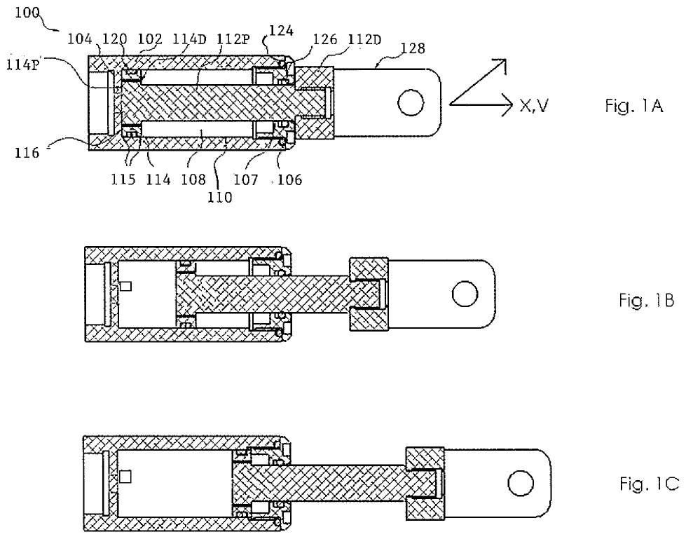

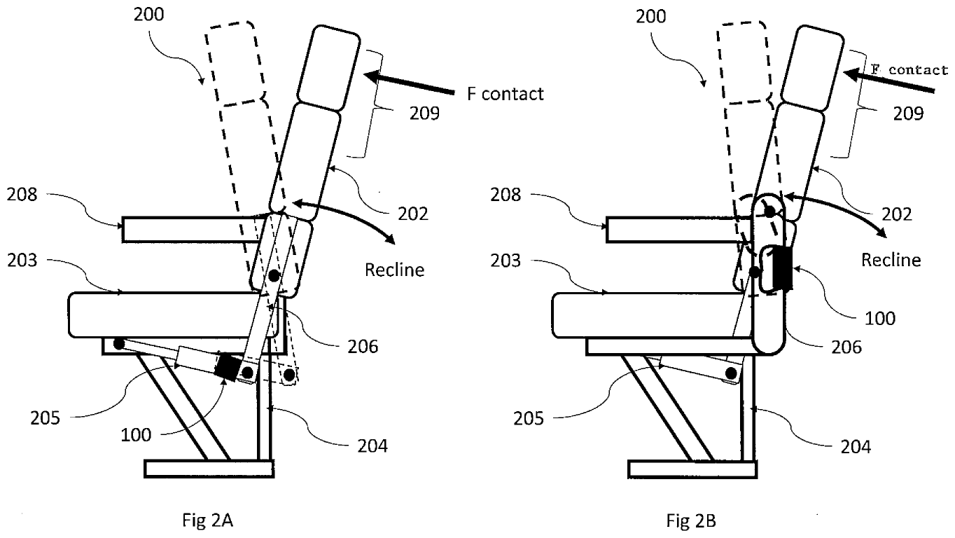

Referring now to FIG. 1A and FIG. 2A, depicted is an embodiment of a piston device 100 with conditional responsiveness, energy absorbing characteristics and reusability, for use with an aircraft seat 200 including a seat back 202 that is susceptible to an aft impact force stemming from a seated passenger behind the seat back 202 whose head strikes the seat back 202 from behind during an aircraft crash pushing the seat back 202 forward. The piston device 100 is configured to exhibit a reaction that is responsive to a directional impact force solely on the condition that the directional impact force exceeds a predetermined threshold, where the piston device advantageously includes dampening mechanisms to dissipate at least a portion of the impact force thereby decreasing the rate at which the head of the aft passenger decelerates after striking the seat back.

As shown in FIG. 1A, the piston device 100 has an elongated hollow cylindrical body 102 defining a longitudinal axis X along which a piston 114 with its head 115 and shaft 112 translates upon release from the body 102 from a compressed position (FIG. 1A) to an extended position (FIG. 1C), with a mid-stroke position therebetween (FIG. 1B), in response to a directional impact force that has a vector component parallel to the longitudinal axis X which exceeds the predetermined threshold.

The hollow cylindrical body 102 defines a sealed chamber 108. The chamber 108 has an inner circumferential surface 110 and includes a first end or proximal end wall 104, and a second end or distal end plug 106 which seals the hydraulic fluid 118 in the chamber 108. The plug 106 has a center threaded-hole 117 through which the shaft 112 movably extends. The piston 114 with its shaft 112 has a length greater than the chamber 108 such that the shaft 112 has a distal portion 112D that extends distally of the distal end plug 106 and remains outside of the chamber 108 when the piston 114 is in its compressed position (FIG. 1A), whereas a proximal portion 112P of the shaft is inside the chamber 108 only when the piston 114 is in its compressed positioned (FIG. 1A), is partially outside of the chamber 108 when the piston 114 is in its mid-stroke position (FIG. 1B) and is generally outside of the chamber 108 when the piston 114 is in its extended position (FIG. 1C). A distal end of the shaft 112 includes a coupler 128 configured to couple the distal end to a component, for example, the seat back 202 of the seat 200 (FIG. 2A and FIG. 2B), so that a force exerted on the seat back 200 is imparted to the piston 114 and its head 115 and shaft 112, and vice versa.

The piston head 115 has a distal face 115D and a proximal face 115P. The distal face 114D faces the distal end plug 106 of the chamber 108 and is configured to abut with a proximal face of the distal end plug 106 when the piston is in the extended configuration (FIG. 1C). The proximal face 114P faces the proximal end wall 104 and is configured to abut with a distal face of the proximal end wall 104 when the piston is in the compressed configuration (FIG. 1A).

As shown in FIG. 1A, between the hollow cylindrical body 102 and the distal plug 106, an outer static seal 124 provides a fluid-tight seal. Between the distal plug 106 and the shaft 112, an inner dynamic seal 126 provides a fluid-tight seal throughout movement of the piston 114 between the compressed and extended positions. The piston 114 may also include a dynamic choke 120 that is configured to guide the piston 114 prevent fluid leakage around the circumference of the piston head 115 during translation of the piston between the compressed and extended positions. In some embodiments, the glide ring 120 has a split ring configuration. As will be appreciated by one skilled in the art, the dynamic seal 126 and the dynamic choke 120 may be constructed of any suitable structure or material. The glide ring as the dynamic choke may have a split ring configuration. The dynamic seal 126 may include, but is not limited to, for example, O-rings, U-cup rings, stacked ring configurations, and piston rings formed from various materials such as rubber, iron, Teflon®, etc. Situated between interfacing surfaces of the piston 114 and the inner surface 110 of the chamber 108, the dynamic seal 126 and/or the dynamic choke 120 is configured to induce static friction between these surfaces that must be overcome in order for the piston to be released from its compressed configuration upon the aft impact and/or to induce dynamic friction that damps motion of the piston translating from the compressed configuration to the extended configuration. As such, in some embodiments, means for conditionally releasing the piston for movement relative to the chamber include friction-inducing structures, for example, the dynamic seal and/or the dynamic choke. Moreover, means for damping motion of the piston after release also include friction-inducing structures, for example, the dynamic seal and/or the dynamic choke. These friction-inducing structures damp motion of the piston by converting kinetic energy into thermal energy.

In use, the piston device of FIG. 1A remains in its compressed configuration with the piston 114 held stationary relative to the chamber by static friction forces provided by the dynamic choke 120 and/or the dynamic seal 126 when the piston device 10 is subjected to aft impact forces that are below the predetermined threshold. However, when the aft impact force, that is, a vector component V of the force F generally parallel to the longitudinal axis X, is greater than the predetermined threshold of the static friction forces, the aft impact force dislodges the piston 114 from its compressed configuration. Where the aft impact force is sufficiently great, the force sends the piston 114 toward the distal end 106 of the chamber where such movement of the piston is damped also by the dynamic friction forces provided by the dynamic choke 120 and/or the dynamic seal 126 with kinetic energy of the piston 114 being converted into thermal energy that heats up components of the piston device 10. A full stroke of the piston 114 is achieved when the aft impact force drives the piston to its full extension with the piston head 115 in contact with the distal end 106, as shown in FIG. 1C.

After a full stroke, the piston device 10 of FIG. 1C can be reset to return to the compressed configuration of FIG. 1A by a force of sufficient magnitude, applied manually or by automation, to overcome the friction forces of the dynamic choke 124 and/or the dynamic seal 126 in the direction from the distal end 106 toward the proximal end 104. After the piston 114 is returned to the compressed configuration of FIG. 1A, the piston device 10 is ready to respond to a subsequent aft impact force that equals or exceeds the predetermined threshold in the same manner as described above.

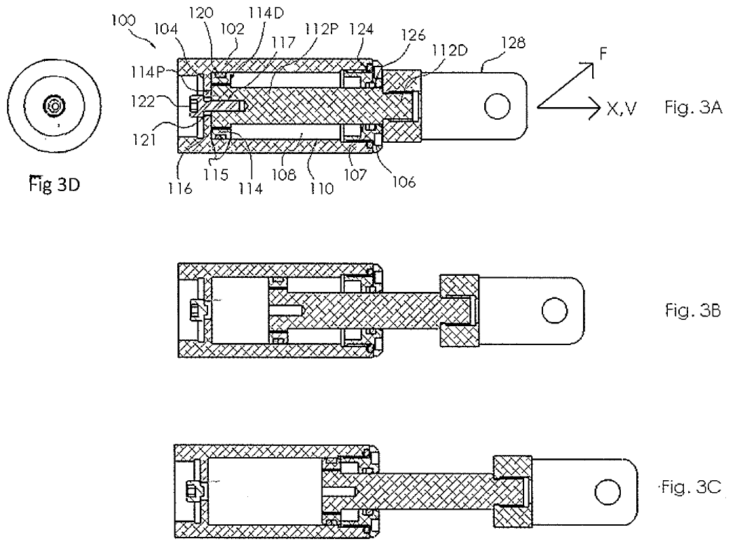

Referring to FIG. 3A, in some embodiments, the piston 114 includes one or more longitudinal ports 116 that define fluid communication channels between the distal face 114D and proximal face 114P of the piston 114 to enable fluid passage in the chamber 108 distal and proximal of the piston head 115 as the piston 114 translates along the longitudinal axis X. And where the chamber 108 is filled with hydraulic fluid 118, as described further below, the ports 116 allow the hydraulic fluid to move in the chamber between the portions distal and proximal of the piston head 115. As understood by one of ordinary skill in the art, any suitable hydraulic fluid 118 may be used within the scope of the present disclosure.

In some embodiments, the piston 114 is advantageously affixed to the body 102, for example, to the proximal end wall 104, for release solely upon the condition that an impact force having a vector component parallel to the longitudinal axis x exceeds a predetermined threshold. In the embodiment of FIG. 3A, the piston device 100 includes a tension fastener or bolt 122 that is configured to secure the piston 114 to the body 102 yet conditionally release the piston 114 from its compressed configuration. The tension bolt 122 has a shaft 123 that extends through a through-hole 121 formed in the proximal end wall 104 and is threaded into a receiving blind hole 115 formed in the proximal face 114P of the piston 114. In the illustrated embodiment, the shaft 123 of the tension bolt 122 is generally parallel, if not coextensive, with the longitudinal axis X of the piston device 100. As a means for conditionally releasing the piston 114, the tension bolt 122 is configured to fracture, break or disintegrate (collectively herein referred to as “rupture”) when it is subjected to a predetermined amount of tension along its longitudinal axis, such as when the piston device 100 is subjected to the directional impact force with a sufficiently large vector component that is parallel to the longitudinal axis X. As such, the predetermined amount of tension required to break the tension bolt 122 corresponds with the aforementioned threshold impact force required to release the piston 114 in activating the piston device 100. As explained below in further detail, in some embodiments of the piston device 100, means for conditionally releasing the piston 114 only when a vector component of the impact force exceeds a predetermined threshold includes the tension bolt 122. As understood by one of ordinary skill in the art, the dimensions, geometry, and material composition of the tension bolt 122 may be modified to determine the amount of force required to rupture the tension bolt 122. Any dimensions, geometries, and/or materials for the tensions bolt 122 that produce a suitable rupture strength may be used within the scope of the present disclosure. As understood by one of ordinary skill in the art, the tension bolt 122 may be affixed to the proximal end wall 104 and the piston 114 by any suitable configuration, including, for example, by any suitable bonding method or compound. This may include, but is not limited to, thermal bonding or the use of adhesives or epoxies.

Also depicted in FIG. 2A and FIG. 2B, the coupler 128 at the distal end of the shaft 112 may be used to couple the HIC piston device 100 to a component, such as the seat back 202 of an aircraft seat 200. The coupler 128 may be formed as a distal end of the distal portion 112D of the shaft 112, or it may be affixed as a separate component by any suitable bonding method such as welding or adhesives. In some embodiments, the coupler 128 may be threaded onto the distal portion 112D of the shaft 112. The coupler 128 may be configured with different geometries based upon the component being coupled to the piston device 100. As understood by one of ordinary skill in the art, any suitable geometry for the coupler 128 may be used within the scope of the present disclosure.

It is understood that FIG. 2A shows the piston device configured in series with a linkage that enables typical seat motion. FIG. 2B shows the linkage inserted into the seat back structural element. The piston device 100 may be configured with different geometries based upon the component being coupled to and the location in the seat, as understood by those skilled in the art.

In use, according to some embodiments, before an impact, the piston device 100 of FIG. 3A and the seat back 202 are arranged with the piston 114 held in the compressed configuration by the tension bolt 122. The dynamic seal 126 forms a fluid-tight seal around the shaft 112, creating an enclosed volume of the hydraulic chamber 108. The hydraulic fluid 118 occupies the volume of the chamber 108 distal of the piston 114. The coupler 128 couples the shaft 112 and the piston 114 to the seat back 202.

During a crash with an aft passenger impact, a directional force F with a vector component V parallel to the longitudinal axis X in a direction from the proximal end wall 104 to the distal plug 106, as shown in FIG. 3A, is exerted on the seat back 202, for example, by a head strike of an aft passenger. The force of vector component V is imparted to the shaft 112 and the piston 114 via the coupler 128. Where magnitude of the vector component V is sufficiently great and exceeds a predetermined threshold, the vector component V places sufficient tension on the tension bolt 122 to cause breakage of the bolt. The breakage of the tension bolt 122 releases the piston 114 to react to the vector component V and move within the chamber 108 from the compressed position toward the distal plug 106.

Notably, because the volume of the chamber 108 is sealed by the dynamic seal 126 and fluid cannot pass around the piston 114 due to the glide ring 120, motion of the piston 114 creates pressure on the hydraulic fluid, which forces the hydraulic fluid 118 to pass proximally through the one or more ports 116 toward the proximal end wall 104. The motion of the piston 114 also creates a pressure drop across the proximal face 114P of the piston 114 that exerts a force proportional to the square of the velocity of the piston 114 in a direction opposing the motion of the piston 114 along the length of the hydraulic chamber 108. This force serves to damp the motion of the piston 114 as it moves along the length of the hydraulic chamber 108 toward the distal plug 106. During this motion, mechanical energy from the motion is converted to thermal energy of the hydraulic fluid 118 by viscous damping, as it is forced through the one or more ports 116 within the piston 114. As a means for damping the motion of the piston when the piston is released for movement relative to chamber, the ports 116 through which the hydraulic fluid passes effectively damp motion of the piston following its conditional release from attachment to the body 102.

The energy dissipation produced by the hydraulic fluid 118 and the force exerted on the piston 114 resulting from the pressure drop across the proximal face 114P of the piston 114 advantageously damp the motion of the piston 114 and serve to reduce the rate at which the passenger's head decelerates when hitting the seat back during an impact. This reduction in rate is intended to decrease the HIC of the impact and thus reduce the amount of injury likely to be caused by the impact of the passenger's head against the seat back in front.

It is understood that because of the volume occupied by the shaft 112 in the portion of the chamber distal of the piston head 115, the volume of hydraulic fluid occupying the chamber distal of the piston head when the piston is in the compressed configuration (FIG. 3A) does not fully occupy the chamber proximal of the piston when the piston is in the extended configuration (FIG. 3C). This difference in volume when the shaft is in the extended configuration is accommodated by a vacuum in the hydraulic fluid on the proximal side of the hydraulic chamber 108, which forms a gas bubble within the volume.

Motion of the piston 114 in a full stroke includes movement from a compressed position to a mid-stroke position and further to an extended position is illustrated in FIG. 3A, FIG. 3B and FIG. 3C. When used in conjunction with a locking linkage 205 in an airplane seat as shown in FIG. 2A and FIG. 2B, the piston device 100 becomes a rigid link in tension with respect to the motion of piston 114 when it reaches the extended configuration. As understood by those skilled in the art, various factors, for example, the stroke length of the hydraulic chamber 108, may be varied to produce varying levels of damping and range of motion for the piston 114. Other factors, for example, the volume of the hydraulic chamber 108, the properties of the hydraulic fluid 118, the diameter of the piston 114, the number of ports 116, and the dimensions of the ports 116 can be changed to alter the damping characteristics of the HIC piston device 100.

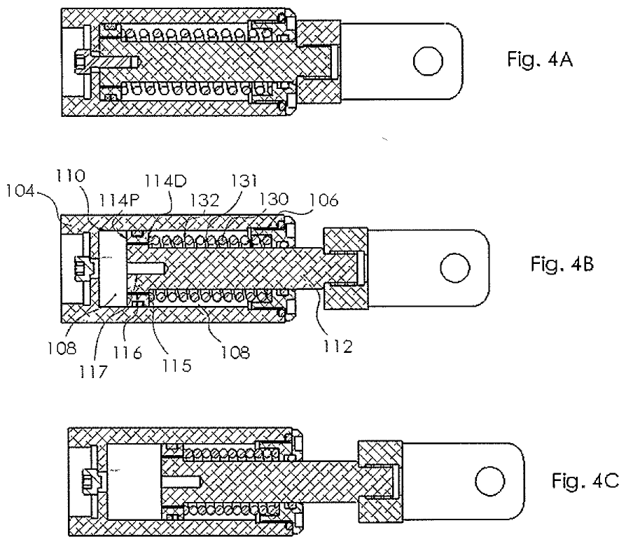

In some embodiments, piston device 100 includes a return spring or coil 130, as shown in FIG. 4A. The return spring 130 is housed within the hydraulic chamber 108 and coiled around the shaft 112 surrounding it circumferentially. As desired or appropriate, the return spring 130 is configured in its neutral configuration or as a preloaded spring (FIG. 4A) to span between and abut with the distal face 114D of the piston 114 and the proximal face of the distal plug 106. With or without preloading, the return spring 130 has space gaps 131 between adjacent coils 132 when the piston is in the compressed configuration (FIG. 4A) prior to an aft impact, such that the return spring 130 can be compressed as shown in mid-stroke in FIG. 4B and fully compressed at full stroke in FIG. 4C. in response to an aft impact. By resisting compression before and after an aft impact of sufficient magnitude to activate the piston device, the return spring 130, in some embodiments, may serve as one or both of a means for conditionally releasing the piston and a means for damping the motion of the piston. As a means for damping the motion of the piston, the return spring resists motion of the piston 114 toward the distal plug 106 in response to the vector component V arising from the aft passenger's head striking the seat back 202 pushing the seat back 202 toward the forward position. The piston 114 continues its damped movement toward the distal plug 106 until the return spring 130 is either in a full compression configuration (FIG. 4C), at which point it becomes rigid in relation to the movement of the piston 114, or in a mid-stroke configuration (in between compressed and extended) (FIG. 4B) where the resistance to compression of the spring overcomes the dissipating vector component V. In either event, the return spring 130 begins to expand and return to its neutral configuration.

As the return spring 130 returns to its neutral/initial configuration, the pressure of the hydraulic fluid 118 in the chamber 108 proximal of the piston 114 increases causing the hydraulic fluid to flow distally through the ports 116 from the proximal face 114P of the piston to the distal face 114D and return to the portion of the chamber distal of the piston head 115. With the vector component fully dissipated, the piston 114 returns to its compressed position, with the majority of the hydraulic fluid occupying the portion of the chamber distal of the piston head 115 and the shaft 112 and the coupler 128 returning the seat back 202 of an aircraft seat 200 toward its upright position so that the seat back 202 does not block the egress of passengers nearby. The gas bubble in the volume that initially formed when the piston moved into the extended configuration collapses under pressure and is reabsorbed into the hydraulic fluid.

It is understood that the tension bolt 122 serves to maintain the piston 114 in a compressed position until a predetermined threshold of vector component V of the aft impact force is applied along the longitudinal axis X in the forward direction. This conditional release of the piston 114 prevents minor contacts with the seat back, such as when a passenger bumps into the seat back in front of them while accessing his or her seat, from inadvertently releasing the piston and causing the seat back to move forward.

However, as understood by one of ordinary skilled in the art, means for conditionally releasing the piston 114 solely when the vector component exceeds a predetermined threshold may include components in lieu of or in addition to the use of a tension bolt 122. The spring 130 as an elastic member is configured as a means for resetting the piston device by returning the piston to its initial configuration following a mid or full stroke.

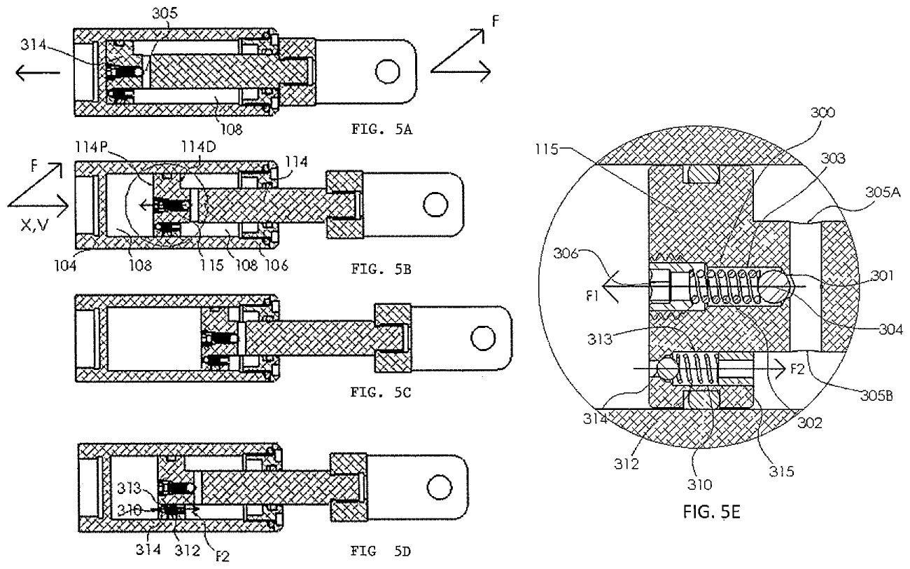

FIG. 5A depicts an alternate embodiment wherein the means for conditionally releasing the piston 114 and the means for damping motion of the piston include one or more check valve mechanisms. As more clearly show in FIG. 5E, the piston 114 is formed with a longitudinal channel 303 through the piston head 115 and a radial channel 305 to provide fluid communication in the chamber proximal and distal of the piston head 115. The radial channel 305 has openings 305A and 305B that are distal of the piston head 115 and they remain open in communication to the chamber 108 so that generally all of the hydraulic fluid can pass from the portion of the chamber distal of the piston head 115 to the portion of the chamber proximal of the piston head 115 before the piston 114 reaches it extended configuration. In the illustrated embodiment, the openings of the radial channel are proximately distal of a junction of the piston head 115 and the shaft 112. The radial channel 305 is in communication with the longitudinal channel 303 at a valve opening 301 that is located at an intersection of the channels 303 and 305. The intersection is situated between first and second openings 305A and 305B. A first or primary check valve mechanism 300 includes a valve member 304, e.g., a spherical valve member or a ball, and a bias member 302, e.g., a spring, both of which are positioned in the longitudinal channel 303, where the relative position of the valve member 304 and the bias member 302 defines a valve flow direction F1 opposite of the translation of the piston 114, e.g., from the valve member 304 toward the bias member 302, as shown in FIG. 5B. As such, the valve flow direction F1 of the first check valve mechanism 300 is in the proximal direction toward the proximal end 104 of the hydraulic chamber 108.

While in a neutral configuration of the check valve mechanism 300 (FIG. 5A), the valve member 304 and the bias member 302 are configured so that the bias member 302 biases the valve member 304 in a closed position, that is, the bias member 302 exerts a predetermined threshold force on the valve member 304 in the distal direction such that the valve member 304 abuts the against the valve opening 301 thereby blocking communication between the channels 303 and 305.

During a crash with an aft passenger impact, a directional force F with a vector component V parallel to the longitudinal axis X in a distal direction is imparted to the piston 114 pushing the piston distally, as shown in FIG. 5B. Such movement of the piston 114 compresses the hydraulic fluid in the chamber 108 forcing the hydraulic fluid into the radial channel 305 against the valve member 304. Where the magnitude of the vector component V is sufficiently great and exceeds the predetermined threshold provided by the bias member 302, the piston 114 exerts sufficient force to inject the hydraulic fluid into the radial channel 305 and push the valve member 304 proximally thereby compressing the bias member 302 and unblocking the valve opening 301. With the valve opening 301 unblocked, the hydraulic fluid enters the longitudinal channel 303, moving past the valve member 304 and the bias member 302 in accordance with the valve flow direction F1 (FIG. 5B), and enters the portion of the chamber 108 proximal of the piston head 115, thereby releasing the piston 11 from its compressed configuration. Accordingly, in some embodiments, a means for conditionally releasing the piston includes the check valve mechanism 300.

As described above, the pressure drop across the proximal face 114P of the piston 114 as a result of the motion of the piston creates a pressure drop across the proximal face 114P of the piston 114 that exerts a force that serves to dampen the motion of the piston 114 as it distally moves along the length of the hydraulic chamber 108 toward the distal plug 106. During this motion, mechanical energy from the motion is converted to thermal energy of the hydraulic fluid as it is forced through the channels 303 and 305. Accordingly, in some embodiment, a means for damping motion of the piston includes the check valve mechanism 300 defining a flow direction that is generally opposite of the motion of the piston. Again, both the energy dissipation produced by the hydraulic fluid during velocity squared damping and the force exerted on the piston 114 resulting from the pressure drop across the proximal face 114P of the piston 114 advantageously damp the motion of the piston 114 and serve to reduce the rate at which the passenger's head decelerates when hitting the seat back during an impact. Full extension of the piston 114 is in shown in FIG. 5C, with nearly all of the hydraulic fluid occupying the portion of the chamber 108 proximal of the piston head 115.

In some embodiments, the condition for releasing the piston 114, including the predetermined threshold pressure exerted by the bias member 302 on the valve member 304, can be adjusted by adjusting the degree of compression of the bias member 302 via a threaded member 306 situated in the longitudinal channel 303, for example, situated near the proximal face 114P of the piston 114. By adjusting the position of the threaded member 306 relative to the piston 114 to increase or decrease compression of the spring 302, the amount of threshold force required to release the piston 114 from its compressed configuration can be adjusted.

It is understood that the piston device 100 may include one or more additional check valve mechanisms, each with its respective spring and valve member, located in a respective channel. In the embodiment of FIG. 5A and FIG. 5E, the piston device 100 includes a second check valve mechanism 310, with a valve member 314 and a spring 312, whose valve flow direction F2 is opposite to the valve flow direction F1, as shown in FIG. 5D. Situated in a longitudinal channel 313 that is generally parallel to the longitudinal channel 303, the valve member 314 is proximal of the spring 312 so that the hydraulic fluid flow in the opposite valve flow direction F2 can return the piston 114 from the extended configuration (FIG. 5C) back to the compressed configuration (FIG. 5A) and reset the piston device 100 in preparation for response to another impact. That is, the piston device is thereby rendered capable of returning the piston 114 into the compressed configuration for another stroke cycle in the reuse of the piston device. Accordingly, in some embodiments, a means for resetting the piston device includes the check valve mechanism 310 defining a flow direction that is opposite to the flow direction of the check valve mechanism 300.

In operation, fluid flow of the hydraulic fluid 118 in the proximal direction in the chamber 108 in response to a first impact is prevented until the pressure within the chamber 108 overcomes the threshold release pressure for the first check valve mechanism 300. Once the pressure is reached, the force on the valve member 304 by the hydraulic fluid overcomes the force exerted on the valve member 304 by the bias member 302, which causes the valve member 304 to dislodge from the valve opening 301 and allow hydraulic fluid 118 to flow through it in the valve flow direction F1 from the portion of the chamber 108 distal of the piston head 115 to the portion of the chamber proximal of the piston head 115.

Once the piston 114 is released and in motion, the same damping force caused by the pressure drop across the proximate face 114P of the piston 114 is exerted on the piston 114 as the piston moves distally. As described above, the injection of the hydraulic fluid 118 through the first check valve mechanism 300 in the valve flow direction F1 (FIG. 5B) converts mechanical energy from the piston 114 into thermal energy of the hydraulic fluid 118.

After the piston 114 has reached the extended position (FIG. 5C), it is reset by an application of a sufficient force, e.g., to the seat back, with a vector component opposite to that of the first impact vector component, by manual or automatic operation, to overcome the threshold release pressure for the second check valve mechanism 310 which allows for opposite fluid flow in the direction F2 (FIG. 5D) through the channel 313 from the portion 114 of the chamber 108 proximal of the piston 114 to the portion of the chamber distal of the piston head 115.

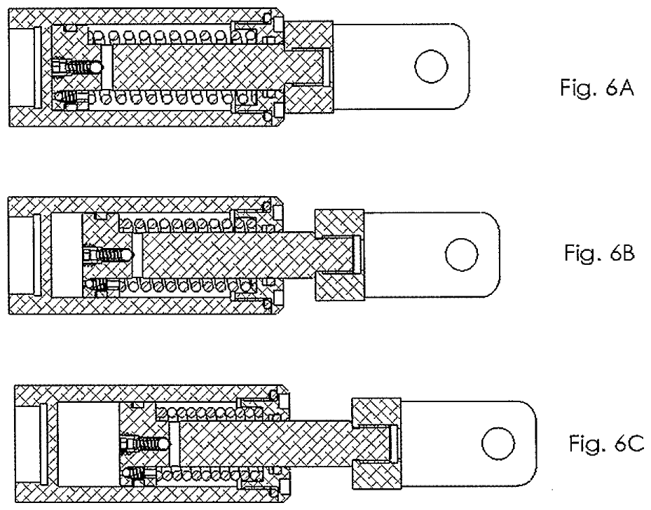

In some embodiments, the piston device 100 includes a return spring 130 which works together with the second check valve mechanism 310 in returning the piston 114 back to its compression configuration, as shown in FIG. 6A. In some embodiments, the return spring 130 is selected to exert a force upon the piston 114 that is greater than the force required to open the second check valve mechanism 310 along the stroke length of the piston 114 within the hydraulic chamber 108. Such a return spring 130 is configured to open the second check valve member 310 and return the piston 114 to the compressed position (FIG. 6C). In other embodiments, the return spring 130 is configured to exert lesser force along the stroke length of the piston 114 so as to partially return the piston 114 merely a portion of the way back to the compressed configuration such that the piston 114 is to receive an additional amount of force to be completely reset.

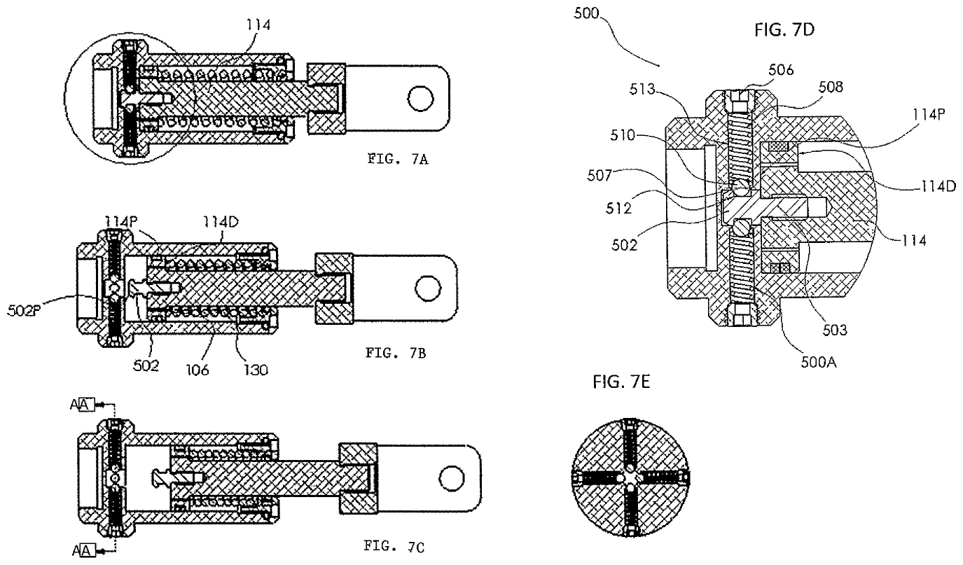

In some embodiments, as depicted in FIG. 7A, means for conditionally releasing the piston 114 include a catch mechanism 500 having a spring 508, a male catch 510, e.g., a ball, and a releasable female catch 512 formed as an indent in a protrusion 502 extending from the proximal face 114P of the piston 114. It is understood that the protrusion 502 may be formed from the proximal face 114P or it may be a component affixed to the piston, such as a head 503 of a bolt 501. In any case, the protrusion 502 is received in a recess 507 formed in the proximal end wall 104 of the body 102 when the piston device 100 is in the compression configuration of FIG. 7A. The spring 508 and the male catch 510, which is proximal of the spring 508, are arranged in a radial channel 513 that is formed in the proximal end wall 104 and in communication with the recess 507 so that the male and female catches 510 and 512 can engage retaining the piston 114 in the compressed configuration.

The depth of the female catch 507 is configured such that only a portion of the male catch 510 is received in and engaged with the female catch 512. The male catch 510 is therefore in a releasable engagement with the female catch 512, and the threshold force required for releasing the piston is adjustable by adjusting the position of a threaded member 506 situated distal of the spring 508 in the channel 513 that is configured to compress the spring 508. Generally, the more deeply the threaded member 506 is screwed into the radial channel 513, the more compressed the spring 508 becomes thereby exerting a greater force upon the male catch 510 and hence a greater threshold force is needed to disengage the catch mechanism 500 and release the piston 114.

For additional engagement force, the piston device 100 may include multiple catch mechanisms 500, including a second catch mechanism 500A, each with its respective male and female catches arranged radially about the recess 507. In some embodiments, each female catch 512 is configured separately. In some embodiments, the female catches are connected forming a collective female catch around the protrusion 502. In any case, each male catch 510 contacts a surface of the female catch 512 at an angle θ. In such a configuration, as is depicted in FIG. 7C, the threshold release force is described by the below equation:

$$F t ∝ {\sum }_{i = 1}^{n} \frac{{S}_{i}}{cos {θ}_{i}} + {K}_{i}$$

where Ft is the threshold release pressure, n is the number of male catches 510 in the mechanical assembly 500, Sᵢ is the force applied by each spring 508 to its respective male catch 510, cos θᵢ is the cosine of the angle at which the individual male catch 510 makes contact with the female catch 512 of the protrusion 502, and Kᵢ is an amount of friction that must be overcome for each catch mechanism 500 before the piston 114 is released. The motion of the piston 114 from the compressed position to the extended position is depicted in FIG. 7A, FIG. 7B and FIG. 7C. As discussed above in the context of FIG. 3A, FIG. 3B and FIG. 3C, the hydraulic fluid is forced through the one or more ports 116 located within the piston 114. A force opposing the motion of the piston 114 down the length of the piston device 100 due to a pressure drop across the proximate face 114P of the piston 114 is formed to dampen an impact.

The embodiment as depicted in FIG. 7A can also be reset by applying a force that compresses the HIC piston device 100, by manual or automatic operation, and that also overcomes a similar force to the threshold release pressure with potentially different values for θi and Ki, as the shape of the protrusion 502 may contact the male catch 510 at a different angle when being moved over the proximal portion 502P of the protrusion 502 in the reverse direction. Such a configuration is depicted in FIG. 7A where the protrusion 502 has a differently shaped proximal portion 502P than it does at the female catch 512.

In some embodiments, the piston device 100 of FIG. 7A includes the return spring 130, in lieu or in addition to the longitudinal ports 106, is configured to return the piston 114 toward its compressed position. In some embodiments, an additional return force is required to reinsert the protrusion 502 in the recess 507 in overcoming one or more male catches 510 encountered by the proximal face 502P of the protrusion 502 in order to be fully reset (with the male and female catches 510 and 512 back in releasable engagement). In some embodiments the return spring 130 may be coupled to the distal face 114D of the piston 114.

In view of the foregoing, it is understood that means for conditionally releasing the piston from its compressed configuration include the friction-inducing structures in some embodiments, the tension bolt 122 in some embodiments, the spring 130, the first check valve mechanism 300 in some embodiments, and the catch mechanism 500 in some embodiments. It is understood that some embodiments of the piston device may include any one of these structures standing alone or in combination with any other of these structures.

In view of the foregoing, it is understood that means for damping the motion of the piston once released include the friction-inducing structures, the longitudinal ports 116 in some embodiments, and the spring 130 in some embodiments, and the first check valve mechanism 300 in some embodiments. It is understood that some embodiments of the piston device may include anyone of these structures standing alone or in combination with any of these structures.

In view of the foregoing, means for resetting or returning the piston to or toward its compressed configuration in reconfiguring the piston device for a subsequent stroke include the second check valve mechanism 310 in some embodiments, and the spring 130 in some embodiments. It is understood that some embodiments of the piston device may include anyone of these structures standing alone or in combination with any of these structures.

The exemplary embodiments described above are not intended to limit the scope of the present disclosure. Alternative embodiments, specifically those featuring alternative means to conditionally release the piston 114 from the compressed position when the piston is subject to an impact force greater than a predetermined threshold, are within the scope of the present disclosure. Alternative embodiments may include the use of, but is not limited to, reverse configurations where spring-loaded male catches are located on the protrusion 502 and female catches are located in the proximal end wall 104. Alternative embodiments may also include magnets, various types of valves, or alternative configurations of springs to releasably secure the piston 114 in the compressed position. Similarly, variations in the composition of the materials used within the HIC piston device 100 and variations of the dimensions of the components of the HIC piston device are encompassed within the scope of the present disclosure. It is further understood that the drawings are not necessarily to scale.

What is claimed is:

1. A threshold-activated piston device for use with an aircraft susceptible and responsive to an impact force, comprising:
an elongated chamber;
a piston; and
means for conditionally releasing the piston for motion relative to the chamber only when the piston is subjected to an impact force greater than a predetermined threshold.

2. The piston device of claim 1, wherein the means for conditionally releasing the piston include a friction-inducing member between a surface of the piston and a surface of the chamber, the friction-inducing member configured to provide the predetermined threshold.

3. The piston device of claim 1, wherein the means for conditionally releasing the piston include a tension bolt configured to rupture only when the impact force is greater than the predetermined threshold.

4. The piston device of claim 1, wherein the means for conditionally releasing the piston include a spring configured to compress only when the impact force is greater than the predetermined threshold.

5. The piston device of claim 1, wherein the means for conditionally releasing the piston include a pre-loaded spring configured to compress only when the impact force is greater than the predetermined threshold.

6. The piston device of claim 1, wherein the means for conditionally releasing the piston include a first check valve mechanism defining a first fluid flow direction, the first check valve mechanism configured to open for fluid flow in the first flow direction only when the impact force is greater than the predetermined threshold.

7. The piston device of claim 1, wherein the means for conditionally releasing the piston include a catch mechanism with a male member and a female member, the catch mechanism having male and female members that disengage only when the impact force is greater than the predetermined threshold.

8. The piston device of claim 1, further comprising means for damping motion of the piston after the piston is released for movement relative to the chamber.

9. The piston device of claim 8, wherein the means for damping motion include a friction-inducing member between a surface of the piston and a surface of the chamber.

10. The piston device of claim 8, wherein the means for damping motion include fluid in the chamber and at least one port in the piston configured to pass the fluid.

11. The piston device of claim 10, wherein fluid includes a rheological fluid whose viscosity is responsive to an electric current or a magnetic field.

12. The piston device of claim 8, wherein the means for damping motion include a check valve mechanism defining a fluid flow direction, the check valve mechanism configured to open for fluid flow in the flow direction only when the impact force is greater than the predetermined threshold.

13. The piston device of claim 8, wherein the means for damping motion include a catch mechanism with a male member and a female member, the catch mechanism having male and female members that disengage only when the impact force is greater than the predetermined threshold.

14. The piston device of claim 1, including means for resetting the piston.

15. The piston device of claim 14, wherein the means for resetting the piston include a spring.

16. The piston device of claim 14, wherein the means for resetting the piston include a check valve mechanism.

17. A piston device for use with an aircraft seat susceptible to an impact force comprising:
an elongated chamber having a proximal end and a distal end, the chamber defining a longitudinal axis;
a piston having a head and a shaft extending along the longitudinal axis, the piston configured for translation along the longitudinal axis from a compressed configuration into an extended configuration in response to the impact force;
a releasable tension fastener connecting the piston and the proximal end, the tension fastener configured to release the piston from the proximal end for the translation when the tension fastener is ruptured by an impact force exceeding a predetermined threshold; and
a coupler configured to couple the shaft to the aircraft seat.

18. The piston device of claim 17, wherein the piston has a longitudinal port configured to pass hydraulic fluid from a first portion of the chamber distal the piston head to a second portion of the chamber proximal the piston head as the piston translates from the compressed configuration into the extended configuration.

19. The piston device of claim 17, further comprising a spring surrounding a shaft of the piston.

20. The piston device of claim 19, wherein the spring is configured to translate the piston from the extended configuration back to the compressed configuration after the piston device has responded to the impact force.

21. The piston device of claim 17, wherein the tension fastener is a bolt whose shaft extends into the piston head.

22. The piston device of claim 20, wherein the shaft is generally parallel with the longitudinal axis.

23. A piston device for use with an aircraft seat susceptible to an impact force comprising:
an elongated chamber having a proximal end and a distal end, the chamber defining a longitudinal axis;
a piston having a piston head and a shaft extending along the longitudinal axis, the piston configured for translation along the longitudinal axis between a compressed configuration and an extended configuration in response to the impact force;
a first check valve mechanism situated in the fluid channel defining a first valve flow direction, the first check valve comprising a first valve member and a first bias member, the valve member configured to move between a closed position blocking the fluid channel, and an open position allows hydraulic fluid to flow through the fluid channel from the second portion of the chamber distal the piston head to the first portion of the chamber proximal the piston head, the bias member configured to bias the first valve member in the closed position except when the impact force exceeds a predetermined threshold; and
a coupler connecting the shaft to the aircraft seat.

24. The piston device of claim 23, wherein the valve member includes a ball and the bias member includes a spring.

25. The piston device of claim 23, wherein the fluid channel includes a longitudinal channel and a transverse channel.

26. The piston device of claim 25, wherein the longitudinal channel is formed in the piston head and the transverse channel is distal of the piston head.

27. The piston device of claim 23, further comprising a threaded member configured to adjust a bias force exerted by the bias member on the valve member.

28. The piston device of claim 23, further comprising a second check valve mechanism comprising a second valve member and a second bias member, the second check valve mechanism defining a second valve flow direction that is generally opposite to the first flow direction.

29. The piston device of claim 23, wherein the second valve flow direction includes hydraulic fluid flowing from the first portion of the chamber proximal the piston head to the second portion of the chamber distal the piston head.

30. The piston device of claim 23, wherein the second check valve mechanism is formed in the piston head.

31. A piston device for use with an aircraft seat susceptible to an impact force comprising:
an elongated chamber having a proximal end and a distal end, the chamber defining a longitudinal axis;
a piston having a piston head and a shaft extending along the longitudinal axis, the piston configured for translation along the longitudinal axis between a compressed configuration and an extended configuration in response to the impact force;
a catch mechanism including a pair of engaged male catch and female catch configured for disengagement when the impact force exceeds a predetermined threshold; and
a coupler connecting the shaft to the aircraft seat.

32. The piston device of claim 31, wherein one of the male and female catches formed on a protrusion on a proximal face of the piston, and the other of the male and female catches situated in the proximal end of the chamber.

33. The piston device of claim 31, further comprising a longitudinal fluid channel formed in the piston, the channel configured for fluid communication between a first portion of the chamber distal the piston head and a second portion of the chamber proximal of the piston head.

34. An aircraft seat system susceptible to an impact force comprising:
an aircraft seat having a seat back;
a piston device comprising:
an elongated chamber having a proximal end and a distal end, the chamber defining a longitudinal axis;
a piston having a head and a shaft extending along the longitudinal axis, the piston configured for translation along the longitudinal axis between a compressed configuration and an extended configuration;
means for conditionally releasing the piston from the compressed configuration when the impact force has a vector component greater than a predetermined threshold.

35. The piston device of claim 34, further comprising means for dampening motion of the piston once released from the compression configuration.

36. The piston device of claim 34, further comprising means for returning the piston toward the compression configuration from the extended configuration.
